(19) United States
(12) Patent Application Publication
(10) Pub. No.: US 2018/0322566 A1
(43) Pub. Date: Nov. 8, 2018

(54) SYSTEM FOR AUTOMATED PAUSE OF E - AUCTION

(71) Applicant: Zycus Infotech Pvt. Ltd., Andheri East-Mumbai (IN)

(72) Inventors: Sawapnali Rane, Andheri East-Mumbai (IN); Kanishka Ghosh, Andheri East-Mumbai (IN)

(73) Assignee: Zycus Infotech Pvt. Ltd., Andheri East-Mumbai (IN)

(21) Appl. No.: 15/588,710

(22) Filed: May 8, 2017

(51) Int. Cl. G06Q 30/08

(52) U.S. Cl. CPC G06Q 30/08

(57) ABSTRACT

The present invention describes a system for automated pause of an E-auction process, the said pause triggered based on preconfigured E-auction pause Rule Creation Engine to pause E-auction at least once during the E-auction process. The automated pause of E-auction includes a status wherein the said E-auction is at hold and not ended, once the hold period for the automated pause of the E-auction is over, the said E-auction shall resume.

### CROSS-REFERENCE TO RELATED APPLICATIONS

This application claims priority to Indian application 201721000818, entitled “AN AUTOMATED SYSTEM FOR PAUSE OF E-AUCTION”, filed on 9 Jan. 2017, the contents of each are incorporated herein in their entirety.

### FIELD OF THE INVENTION

The present invention relates to electronic auction and procurement. More particularly, it relates to a system for automated pause of E-auction process for a predetermined time based on preconfigured decision rules.

### BACKGROUND OF THE INVENTION

Electronic auction (E-auction) is an e-business between suppliers and bidders, which takes place on an electronic marketplace are very well known in the prior art. The traditional E-auctions provide a platform for the sale of a bid item, from a process of taking bids from bidders and selling to the highest bidder. There are two different modes of E-auction namely forward auction and the reverse auction. In the forward auction, a single seller offers a product/service for sell and plurality of buyers competing for securing the business by bidding higher price, while in the reverse E-auction the buyers makes the plurality of sellers aware of their intent of buying a specific product/service and the plurality of sellers bid against one another to secure the buyers business by bidding lower price. The reverse E-auction type is favoured by buyers as published prices of custom made product/services are not available and it gets difficult to identify the potential seller of a specific customised product/service. The reverse E-auction is one-sided, i.e. one buyer and a plurality of suppliers bidding for the business. The process of reverse E-auction requires the buyer to define the product/service requirement and conduct an auction to develop the potentially new supply relationship.

The main issue with the tradition reverse E-auction is that ones the buyer defines the prerequisite information regarding the product/service, there is no way for the buyer to pause the E-auction based on various parameters such as bid frequency, or any other statistical parameters. In addition, there is no facility for restarting the E-auction for a defined period of time based on the buyer's discretion.

Therefore, there is a need for a system for automated pause of E-auction based on the buyer's discretion. Accordingly, the present invention describes a system and a method for automated pause of E-auction process triggered based on preconfigured decision rules to pause the E-auction at least once during the E-auction process, and once the pause hold time is over the E-auction can resume.

### SUMMARY OF THE INVENTION

It is therefore, an object of the present invention to provide a system for automated pause of E-auction process for a predetermined time based on preconfigured decision rules.

It is a further object of the present invention to provide a system containing preconfigured decision rules to restart the E-auction after the automated pause time is over.

Accordingly, the present invention describes an E-auction system and a method for triggering an automated pause in an E-auction process based on preconfigured decision rules for a predetermined time and further restarting the said E-auction process once the said automated pause hold time is over.

The present invention describes a system and a method for triggering an automated pause of an E-auction process comprising of a host computer system, at least one database component associated with the said host computer system, a communication interface for accessing the said host computer system from a plurality of remote input/output devices to select the said automated pause, the business process element, further comprising of an E-auction pause selection system to trigger the said automated pause of the said E-auction based on a preconfigured E-auction pause rule creation engine to pause the said E-auction at least once during the said E-auction process. The said pause of the said E-auction includes a status wherein the said E-auction is at hold and not ended, the hold of the said E-auction shall be for a pre-configured time period based on the said preconfigured E-auction rule creation engine, once the hold period for the pause of auction is over, the said E-auction shall resume. During the pause of the said E-auction the bids submitted by the bidder shall remain in queue and shall be submitted into the said E-auction, once the pause is released by the said system.

Further, the pause of the said auction can be released either based on the said pre-configured decision rule or manually based on discretion of the buyer. After the release of the said pause, the said E-auction either resumes with the balance time left for the said E-auction to conclude or the said E-auction can be restarted with an extended predetermined time by the buyer. The decision rules associated with the said E-auction rule creation engine to pause the said E-auction includes at least one of the decision rules to pause the said E-auction based on bid frequency, statistical parameters, preconfigured parameters, value of bid, time factor.

These and other objects and advantages of the present invention will become apparent from a reading of the following specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

In accordance to the present embodiment of the present invention, there is provided a system for automated pause of E-auction process, said system comprises a communication interface for accessing the host computer system from a plurality of remote input/output devices to select E-auction pause, the business process element, further comprising of an E-auction pause selection system to trigger pause of E-auction based on preconfigured E-auction pause Rule Creation Engine to pause E-auction at least once during the E-auction process. The pause of E-auction includes a status wherein E-auction is at hold and not ended, the hold of E-auction shall be for a pre-configured time period based on preconfigured E-auction rule creation engine, once the hold period for the pause of auction is over, the E-auction shall resume. During the pause of the E-auction the bids submitted by the bidder shall remain in queue and shall be submitted into the E-auction, once the pause is released by the system. The pause of the auction can be released based pre-configured decision rule or else manually based on discretion of the buyer. Once the pause of the auction is released the auction resumes with the balance time left for the auction to conclude or lese the auction resumes with an extended time pre-decided by the buyer. The system includes an E-auction pause Rule Creation Engine adapted for selection of pause of auction includes decision rules to pause an ongoing auction at least once during the E-auction process. The decision rules associated with the E-auction Rule creation engine to pause E-auction includes at least one of the following decision rules—pause of E-auction based on bid frequency, statistical parameters, preconfigured parameters, value of bid, time factor.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A system for triggering an automated pause of an E-auction process comprises of:
i. a host computer system;
ii. at least one database component associated with the said host computer system;
iii. a communication interface for accessing the said host computer system from a plurality of remote input/output devices to select the said automated pause, the business process element, further comprising of:
i. an E-auction pause selection system to trigger the said automated pause of the said E-auction based on a preconfigured E-auction pause rule creation engine to pause the said E-auction at least once during the said E-auction process.

2. The system for triggering an automated pause of an E-auction as claimed in claim 1, wherein the said system includes a status wherein the said E-auction is at hold and not ended, the hold of the said E-auction shall be for a pre-configured time period based on the said preconfigured E-auction rule creation engine, once the hold period for the pause of auction is over, the said E-auction shall resume.

3. The system for triggering an automated pause of an E-auction as claimed in claim 1, wherein during the said automated pause the bids submitted by the bidder shall remain in queue and shall be submitted into the said E-auction, once the said automated pause is released by the said system.

4. The system for triggering an automated pause of an E-auction as claimed in claim 1, wherein the said E-auction rule creation engine to pause the said E-auction includes at least one of the decision rules to pause the said E-auction based on bid frequency, statistical parameters, preconfigured parameters, value of bid, time factor.

5. A method for triggering an automated pause of an E-auction process comprises of:
i. a host computer system;
ii. at least one database component associated with the said host computer system;
iii. a communication interface for accessing the said host computer system from a plurality of remote input/output devices to select the said automated pause, the business process element, further comprising of:
iv. an E-auction pause selection method to trigger the said automated pause of the said E-auction based on a preconfigured E-auction pause rule creation engine to pause the said E-auction at least once during the said E-auction process.

6. The method for triggering an automated pause of an E-auction as claimed in claim 1, wherein the said method includes a status wherein the said E-auction is at hold and not ended, the hold of the said E-auction shall be for a pre-configured time period based on the said preconfigured E-auction rule creation engine, once the hold period for the pause of auction is over, the said E-auction shall resume.

7. The method for triggering an automated pause of an E-auction as claimed in claim 1, wherein during the said automated pause the bids submitted by the bidder shall remain in queue and shall be submitted into the said E-auction, once the said automated pause is released by the said system.

8. The method for triggering an automated pause of an E-auction as claimed in claim 1, wherein the said E-auction rule creation engine to pause the said E-auction includes at least one of the decision rules to pause the said E-auction based on bid frequency, statistical parameters, preconfigured parameters, value of bid, time factor.
